(19) United States
(12) Patent Application Publication
(10) Pub. No.: US 2017/0015039 A1
(43) Pub. Date: Jan. 19, 2017

(54) CONFORMING COOLING METHOD AND MOLD

(71) Applicant: Honda Motor Co., Ltd., Tokyo (JP)

(72) Inventor: Alan J. Hughes, Prospect, OH (US)

(21) Appl. No.: 15/281,627

(22) Filed: Sep. 30, 2016

Related U.S. Application Data
(63) Continuation-in-part of application No. 13/830,163, filed on Mar. 14, 2013.
Application No. 13/830,163 is a continuation-in-part of application No. 14/591,906, filed on Jan. 7, 2015.

(51) Int. Cl. B29C 45/73

(52) U.S. Cl. CPC B29C 45/7312

(57) ABSTRACT

A method for forming a conformal fluid circulating passage in a mold includes providing a mold including a molding surface with an open passage thereon, the depth of the passage substantially conforming to the contour of the molding surface, the passage defining a plurality of open fluid channels including a first channel, a second channel downstream of the first channel and a third channel downstream of the second channel; and wherein each fluid channel defines a centerline that extends from the bottom of the open passage to the molding surface and a channel longitudinal centerline, and the method includes maintaining a common distance between the longitudinal centerlines and the molding surface and between the centerlines of adjacent channels.

### BACKGROUND

Various types of part molding are known. For example, plastic parts are commonly produced by injection molding and other molding techniques. Of particular interest here are those molding techniques wherein mold temperature must be controlled, such as by cooling to account for heat buildup from the injection or other introduction thereto of molten molding material (e.g., molten plastic).

Commonly, mold cooling has been accomplished by boring a series of interconnected cooling channels into the mold and circulating a cooling fluid, such as water, through the cooling channels. Such cooling channels are frequently bored into a mold from a rear (mounting) side of a mold, but connecting channels may also emanate from other surfaces as well. Aside from an inlet(s) and outlet(s), openings to the outside of the mold are normally plugged to prevent unintended leakage of cooling fluid.

While this technique may be generally effective at reducing overall average mold temperature, it is not without problems. One such problem is the non-uniform cooling that typically results. More particularly, the known technique of circulating cooling fluid through bored cooling channels frequently results in a greater cooling of certain mold parts than others. Consequently, a mold cooled in this manner may have temperature disparities that can negatively affect part cycle times, part quality, etc. Another problem with this known mold cooling technique is its inability to circulate cooling fluid near the actual molding surface of a mold having a contoured shape, at least not in a uniform manner.

It is also known to provide conformal cooling passages within a mold for purposes of cooling the mold and/or a part produced by the mold. In particular, conformal cooling passages can be used to provide more uniform cooling of the part produced by the mold. Cooling passages are conformal when they generally conform to or follow the contour of the part produced by the mold and are disposed beneath the finished mold surface. When the part to be produced by the mold has a relatively complex shape, provisioning the mold with the conformal cooling passages can be difficult.

### SUMMARY

According to one aspect, a part producing mold having a cooling fluid passage defined therein comprises a channel defined in a mold surface of the mold by spaced apart lateral walls depending from the mold surface of the mold toward a closed bottom of the channel. A nonconsumable steel weld support is received in the channel and positioned adjacent the closed bottom. A bridge welded is across the channel onto and above the weld support and directly to the lateral walls for closing the channel and defining the fluid passage.

According to another aspect, a part-producing mold having improved cooling capabilities, comprises at least one conformal cooling passage located subjacent to a molding surface to be cooled. The at least one conformal cooling passage is formed from a series of interconnected open channels placed in a molding surface of the mold, the channels substantially conforming to the contour of the molding surface, and a bridging weld located within each channel. The bridging weld comprises a series of connected weld beads. The bridging weld spans and seals each channel and is located at some distance from a bottom of each channel so as to form an enclosed cooling passage at the bottom thereof. A plurality of weld beads solidly fills a remaining volume of each channel above the bridging weld to close each channel. The weld beads at an open end of each channel are shaped to conform to the molding surface of the mold surrounding that channel. An inlet is associated with the at least one conformal cooling passage for receiving pressurized cooling fluid from a source thereof, and an outlet is associated with the at least one conformal cooling passage for expelling cooling fluid after the cooling fluid has passed through the at least one conformal cooling passage. According to a further aspect, a method for forming a conformal fluid circulating passage in a part-producing mold, comprises providing a mold including a molding surface with an open passage thereon, the depth of the passage substantially conforming to the contour of the molding surface, the passage defining a plurality of open fluid channels including a first channel, a second channel downstream of the first channel and a third channel downstream of the second channel, the bottom of the passage in at least a portion of the first channel has an elevation different than the bottom of the passage in at least a portion of one of the second channel and the third channel. Each fluid channel defines a centerline that extends from the bottom of the open passage to the molding surface and a channel longitudinal centerline, and the method includes maintaining a common distance between the longitudinal centerlines and the molding surface and between the centerlines of adjacent channels.

### BRIEF DESCRIPTION OF THE DRAWINGS

FIG. 1 is a top elevational view of a part producing mold having a fluid passage defined therein.

FIG. 2 is a cross-sectional view taken along the line 2-2 of FIG. 1 showing the fluid passage.

FIGS. 3A-3E are cross-sectional views illustrating a method for forming the fluid passage in the mold according to one exemplary embodiment.

FIGS. 4A-4D are cross-sectional views illustrating a method for forming the fluid passage in the mold according to an alternate exemplary embodiment.

FIGS. 5A-5D are cross-sectional views illustrating a method for forming the fluid passage in the mold according to another alternate exemplary embodiment.

FIGS. 6A-6D are cross-sectional views illustrating a method for forming the fluid passage in the mold according to yet another alternate exemplary embodiment.

FIG. 7 is a top elevational view of a part-producing mold having a circuitous fluid passage defined therein according to yet another alternate exemplary embodiment.

FIG. 8 is a cross-sectional view taken along line 8-8 of FIG. 7, depicting a number of open channels cut into the molding surface of the mold during one step of a method of the present invention, so as to form the fluid passage of FIG. 7.

FIG. 9A is an enlarged cross-sectional view of one of the open channels of FIG. 8, with a bridging weld placed therein in a subsequent step to form an underlying enclosed fluid passage.

FIG. 9B is a cross-sectional view showing the previously open channel of FIG. 9a fully filled to form a sealed fluid passage.

FIG. 10 shows the mold of FIG. 8 with the conformal fluid passage of FIG. 7 fully formed therein after completion of a fluid passage forming method of the present disclosure.

### DETAILED DESCRIPTION

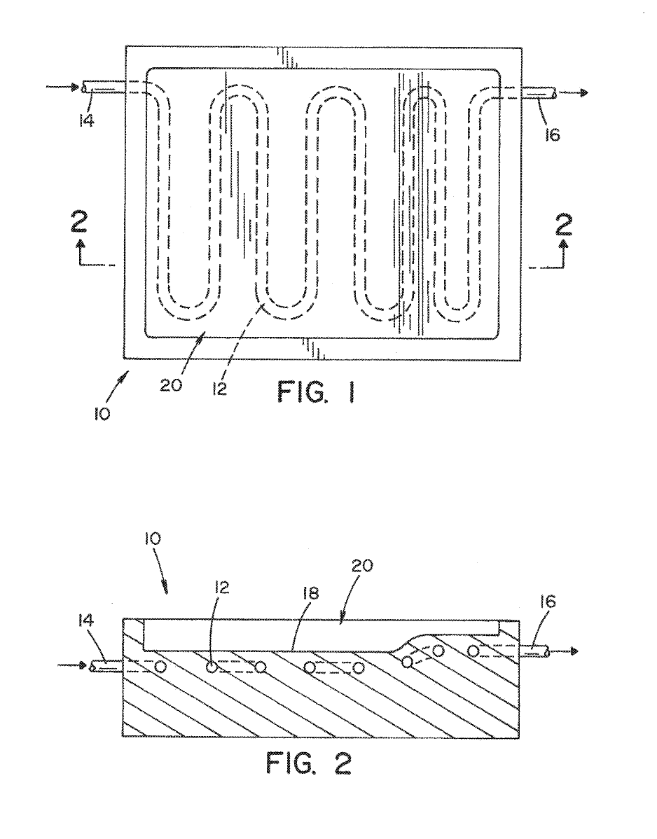

With reference now to the drawings wherein the showings are for purposes of illustrating one or more exemplary embodiments and not for purposes of limiting same, FIG. 1 is a plan view of a part producing mold 10 having a fluid passage 12 defined therein. Although the mold 10 and the fluid passage 12 can only be shown in two dimensions herein, it should be understood, and is more readily apparent from FIG. 2 that the mold 10 would also generally have a contoured shape in a third dimension instead of the planar shape conveyed herein. That is, while the portion of the mold 10 overlying the fluid passage 12 may be planar, it is more likely to have at least some contour. As is known and understood by those skilled in the art, the fluid passage 12 can be a cooling fluid passage through which a coolant is directed for cooling the part producing mold 10 and/or a part (not shown) molded by the part producing mold 10. In the illustrated embodiment, the fluid passage 12 follows a circuitous path through the part producing mold 10 from a coolant inlet 14 to a coolant outlet 16. As is to be appreciated and understood by those skilled in the art, the particular path followed by the fluid passage 12 need not be limited to that shown. In particular, the path, size and spacing of the fluid passage 12 can vary as necessary to provide the desired cooling effect. Further, while only one fluid passage 12 is shown and described herein, it will be appreciated and understood that more than a single fluid passage could be provided.

As shown in the illustrated embodiment, and with additional reference to FIG. 2, the fluid passage 12 is disposed below a molding surface 18 of the mold 10 and can generally follow a contour of the molding surface 18. The molding surface 18 can be contoured, as shown in the illustrated embodiment. In the illustrated embodiment, the mold 10 is shown as a single mold half but it is to be appreciated that another mold half can be provided (though not shown herein) to close a mold cavity 20 as is known and understood by those skilled in the art.

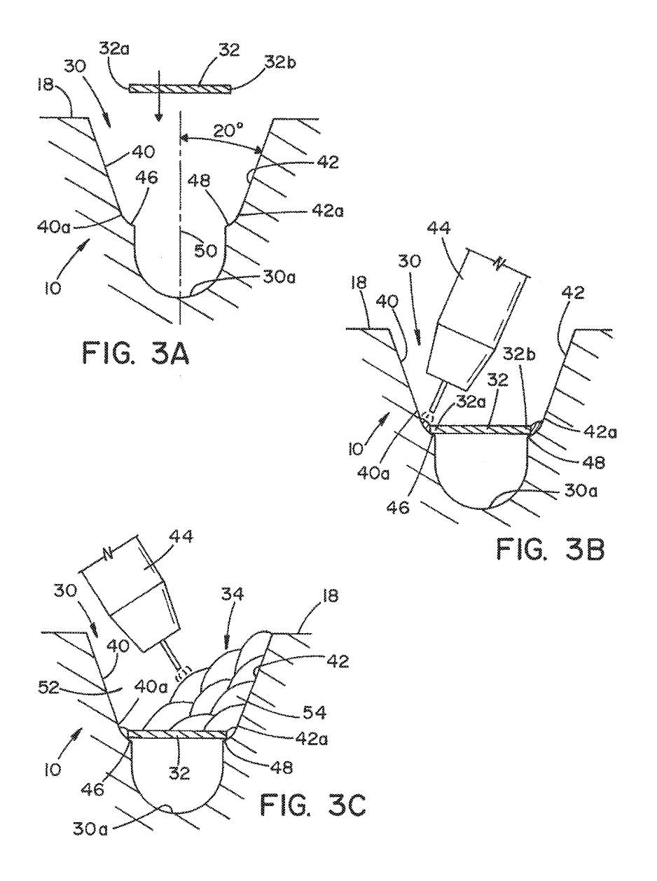

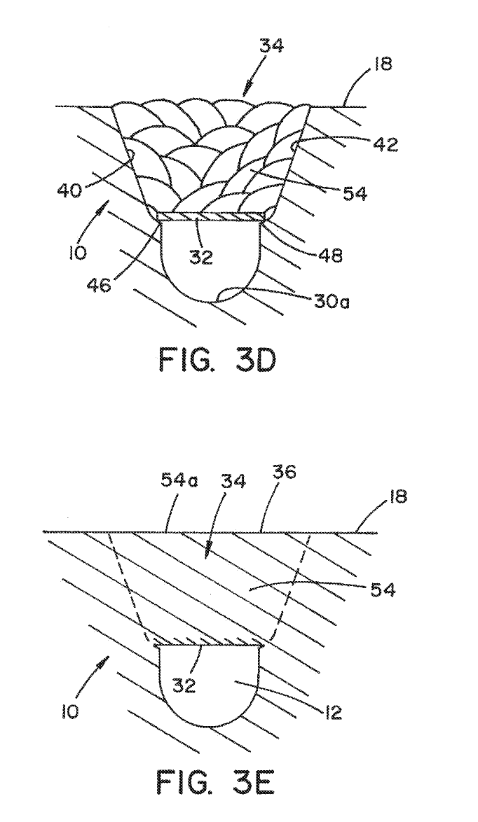

With further reference to FIGS. 3A-3E, and as will be described in more detail below, the mold 10 having the fluid passage 12 defined therein can include a channel or open passage 30 defined in the molding surface 18 of the mold 10, a weld support 32 received in the channel 30 and a bridge 34 welded across the channel 30 above the weld support 32 for closing the channel 30 and defining the fluid passage 12. Additionally, the mold 10 can include a class A machined surface 36 including and extending across the molding surface 18 of the mold 10 and the bridge 34.

A method for forming the fluid passage 12 in the mold 10 will now be described according to an exemplary embodiment. In the method, the weld support 32 is installed in the channel 30 defined in the molding surface 18 of the mold 10 as shown in FIG. 3A. After the weld support 32 is installed, the bridge 34 is welded across the channel 30 above the weld support 32 for closing the channel 30 as shown in FIG. 3C. In the embodiment of FIGS. 3A-3E, the weld support 32 is a nonconsumable weld support, though this is not required. Additionally, the weld support 32 of this embodiment can be a strip of rigid material (e.g., steel) that is installed in the channel. The weld support 32 can have one of a generally planar configuration or a curved configuration, and is shown having a generally planar configuration in the embodiment depicted in FIGS. 3A-3E.

Installing the weld support 32 in the channel 30 can include welding the weld support 32 within the channel 30 at a location spaced apart from a lower end 30a of the channel 30 and from the molding surface 18. This welding of the weld support 32 within the channel 30 can include welding a first end edge 32a of the weld support 32 to a first lateral wall 40 defining the channel 30 and a second end edge 32b of the weld support 32 to a second lateral wall 42 defining the channel 30. This step of welding the weld support 32 within the channel 30 (i.e., welding the first and second edge edges 32a, 32b to the first and second lateral walls 40, 42) precedes and is separate from the step of welding the bridge 34 across the channel 30 above the weld support 32 in the embodiment illustrated in FIGS. 3A-3E. Thus, the weld support 32 is a separate and disparate element from the bridge 34 in the depicted embodiment. Welding of the weld support 32 within the channel 30 can be done using a conventional TIG welder such as the illustrated welder 44, though other types of welders could be used if desired. Alternatively, no specific welding of the weld support 32 need be done and welding of the bridge 34 could commence after placement of the weld support 32 without a separate step of welding the weld support 32 in position.

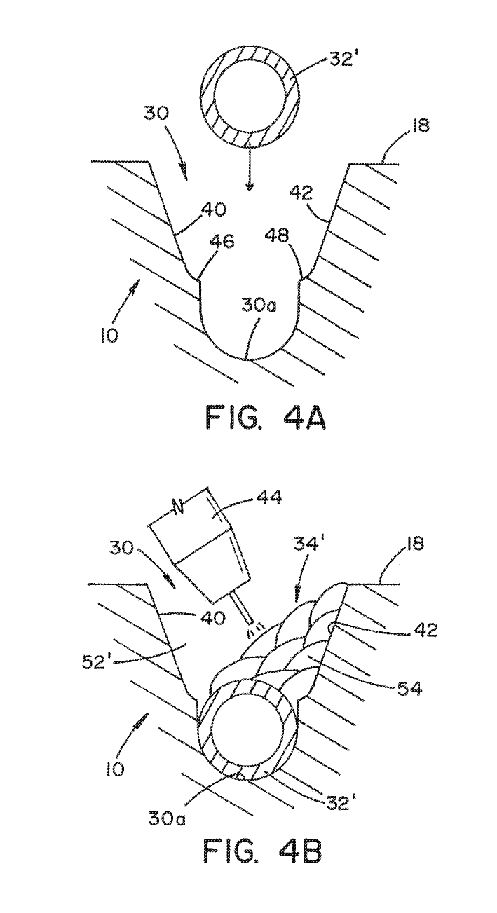

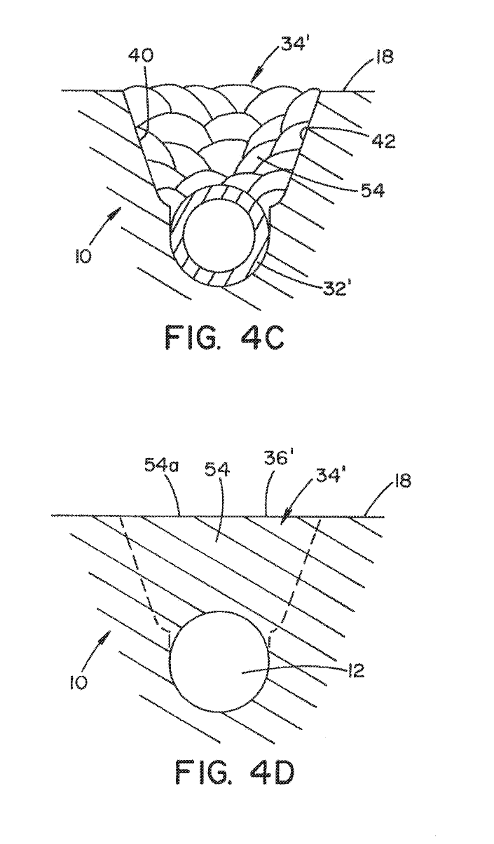

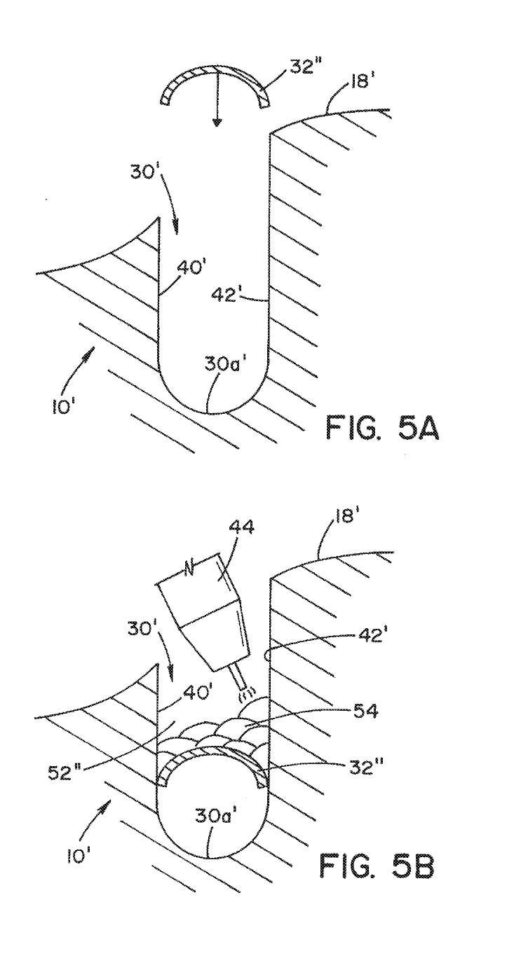

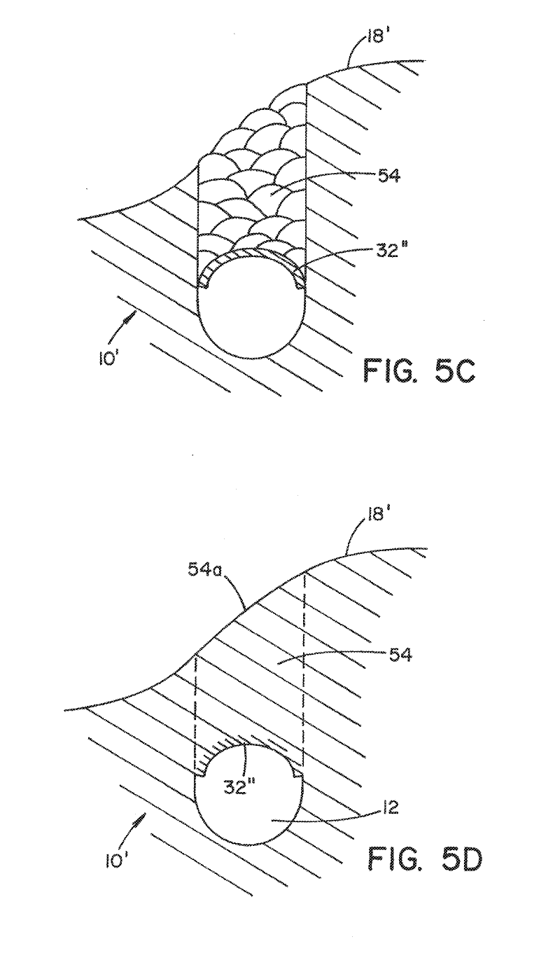

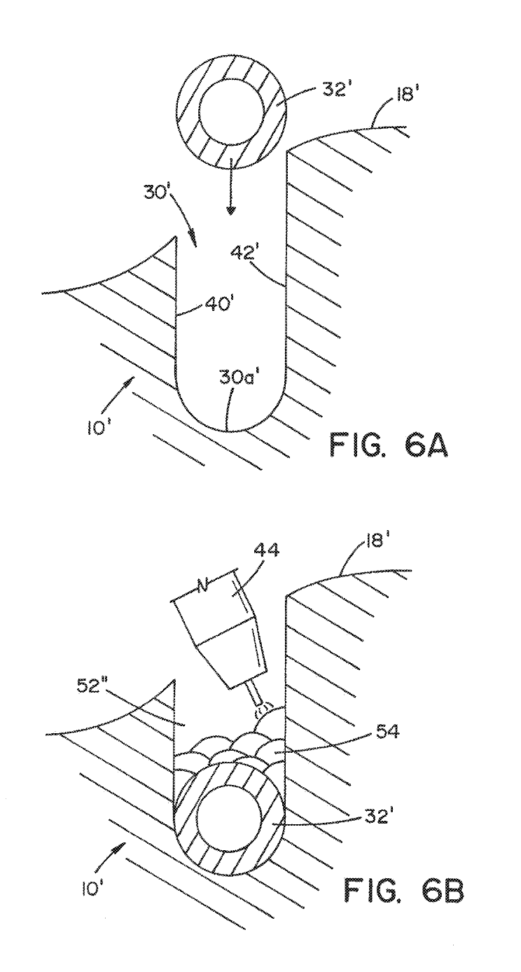

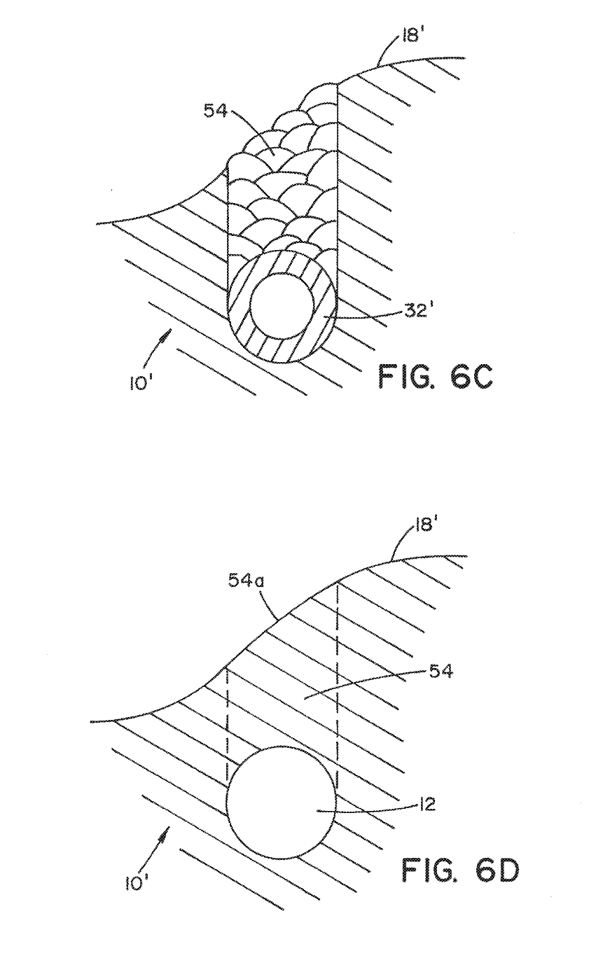

The channel 30 is defined by the spaced apart lateral walls 40, 42 that depend from the molding surface 18 of the mold 10. The spaced apart lateral walls 40, 42 can be at least one of parallel with one another (e.g., as depicted in the embodiments of FIGS. 5A-5D and FIGS. 6A-6D) or angled so that lower ends thereof converge toward one another (e.g., as shown in the embodiment depicted in FIGS. 3A-3E and 4A-4D) or curved (embodiment not shown). In the embodiment of FIGS. 3A-3E, the spaced apart lateral walls 40, 42 are angled and lower ends 40a, 42a of the spaced apart lateral walls 40, 42 converge toward one another but are spaced apart from the lower end 30a of the channel 30. Additionally in the illustrated embodiment, spaced apart shoulders 46, 48 are defined adjacent to lower ends 40a, 42a of the spaced apart lateral walls 40, 42 and the shoulders 46, 48 are spaced apart from the lower end of the channel 30a. The lower end 30a can depend from the shoulders 46, 48 and have a generally curved configuration that is U-shaped in the embodiment illustrated in FIGS. 3A-3E. As shown, the weld support 32 can rest on the shoulders 46, 48. That is, the shoulders 46, 48 can extend inwardly toward one another relative to the lateral walls 40, 42 and can define a dimension that is shorter than a dimension of the weld support 32 spanning the channel 30. In particular, in the illustrated embodiment, the spaced apart shoulders 46, 48 are defined along the lateral walls 40, 42 defining the channel 30. The spaced apart shoulders 46, 48 are spaced apart from the lower end 30a of the channel 30 and spaced apart from the molding surface 18 of the mold in a direction parallel with a depth of the channel (e.g., the depth dimension extending along the axis 50 shown in FIG. 3A). Also as shown, the spaced apart lateral walls 40, 42 can be angled at approximately 20 degrees relative to a depth of the channel 30 (i.e., the depth defined along the axis 50) in the illustrated embodiment, though this is not required.

The step of welding the bridge 34 across the channel 30 above the weld support 32 for closing the channel 30 is shown in progress in FIG. 3C. Particularly, welding the bridge 34 across the channel 30 can include filling a cavity 52 defined between the weld support 32 and the molding surface 18 of the mold with a fill material 54. In the illustrated embodiment, the fill material 54 is weld deposit material from the welder 44 that is incrementally deposited to form the bridge 34 via filling the cavity 52. Filling the cavity 52 can include filling an entirety of the cavity and can further include filling the cavity 52 with the fill material 54 beyond the molding surface 18 of the mold as shown in FIG. 3D. That is, the fill material 34 can be deposited within the cavity 30 above the weld support 32 so that the fill material 54 completely fills the cavity 52 and overflows from the cavity 52 so as to extend upward beyond the molding surface 18 of the mold 10. Such filling can ensure complete filling of the cavity 52 without any voids. It is to be appreciated by those skilled in the art that the step of welding the bridge 34 can be at least one of robotically welded or manually welded. For example, a 3-D welding process, such as a TIG, MIG, Stick or GAS welding process can be used to deposit the fill material 54 within each channel 30.

Thereafter, the fill material 54 can be reduced, particularly the fill material 54 filled beyond the surface of the mold 18 can be reduced, so that an upper surface 54a of the fill material 54 is contiguous with the molding surface 18. In one embodiment, such reduction of the fill material 54 is obtained by machining the fill material 54 until a class A machined surface 36 extends from the molding surface 18 of the mold 10 across the bridge 54 as shown in FIG. 3E. The result, as shown in FIG. 3E, is a closed fluid passage 12 defined by the weld support 32, and the bridge 34 both disposed above the fluid passage 12 and integrated as part of the mold 10 via the welding processes discussed hereinabove.

Optionally, the method described in FIGS. 3A-3E can include cutting the channel 30 into the molding surface 18 of the mold 10 before installing the weld support 32 and welding the bridge 34, though this is not required. In particular, the mold 10 can be provided with the channel 30 already defined therein so that the method need not require the step of cutting the channel 30 into the molding surface 18 of the mold 10. In one embodiment, though again not required, the method can include forming the mold 10 and the molding surface 18 of the mold 10 with the channel 30 by at least one of casting the mold 10, molding the mold 10 or welding the mold 20, techniques that are known and understood by those skilled in the art.

With reference now to FIGS. 4A-4D, a method for forming the fluid passage 12 in the mold 10 will be described according to an alternate exemplary embodiment. The method of FIGS. 4A-4D can be the same or similar to the method of FIGS. 3A-3E except as indicated hereinbelow and thus like reference numbers will be used to identify like elements and like reference numbers with the addition of a prime symbol (C) will be used to identify corresponding elements that vary between the embodiments. Like the method of FIGS. 3A-3E, the method of FIGS. 4A-4D can include installing a weld support 32′ in the channel 30 defined in the molding surface 18 of the mold 10 and can include welding a bridge 34′ across the channel 30 above the weld support 32′ for closing the channel 30. Details of the channel 30 in FIGS. 4A-4D can be as described in connection with the channel 30 of FIGS. 3A-3E.

Unlike the weld support 32, the weld support 32′ has a generally curved configuration. In particular, the weld support 32′ can have a tubular configuration for defining the fluid passage 12 with a generally circular cross-section. As shown, the curvature of the tubular weld support 32′ can match the curvature of the lower end 30a of the channel 30 so that the weld support 32′ can be complementarily received within the channel 30 against the lower end of 30a in tight fitting arrangement as depicted in FIG. 4B. Accordingly, installing the weld support 32′ in the channel 30 defined in the molding surface 18 of the mold 10 involves positioning the weld support 32′ against the lower end 30a of the channel 30 as shown in FIGS. 4A and 4B. Due to the complementary fit, no welding of the weld support 32′ need be done as discussed above in connection with the weld support 32. Instead, once the weld support 32′ is in position, the bridge 34′ can be welded across the channel 30 above the weld support 32′ for closing the channel 30. Such welding of the bridge 34′ can be as described hereinabove in connection with the bridge 34 of FIGS. 3A-3E. That is, welder 44 can be used to deposit a fill material 54 (e.g., weld material) within cavity 52′ defined between the weld support 32′ and the molding surface 18 of the mold 10.

Like the method of FIGS. 3A-3E, welding the bridge 34′ can include fully filling the cavity 52′ with the fill material 54 and can further include filling the cavity 52′ with the fill material 54 beyond the molding surface 18 of the mold as shown in FIG. 4C. Thereafter, the fill material 54 filled beyond the molding surface 18 of the mold 10 can be reduced so that the upper surface 54a of the fill material 54 is contiguous with the molding surface 18 of the mold 10 as shown in FIG. 4D. As discussed above, this can include machining the fill material 54 to create a class A machined surface 36′.

In one embodiment, the weld support 32′ is a consumable weld support. In particular, the weld support 32′ can be consumed after the bridge 54 is welded across the channel 30 above the weld support 32′ so that the weld support 32′ no longer occupies any space within the mold 10. In one embodiment, the weld support 32′ is a consumable weld support that is dissolved after welding the bridge 54 across the channel 30. Such dissolving of the weld support 32′ can include flushing a dissolving material (e.g., water) through the fluid passage 12 to dissolve and remove the weld support 32′ from the mold 10. In one embodiment, the consumable weld support 32′ is formed from a semi-solid paste derived from a borax or sulfur based slurry, though other compositions could be used.

With reference now to FIGS. 5A-5D, another method for forming the fluid passage in a mold will be described. The method depicted in FIGS. 5A-5D can be the same as either of the methods of FIGS. 3A-3E or FIGS. 4A-4D except as indicated below. Like elements are shown in FIGS. 5A-5D with like reference numbers and corresponding elements are shown with like reference numbers with the addition of a prime symbol. In general, the method of FIGS. 5A-5D is the same as the previously described methods in that a weld support 32″ is installed in a channel 30′ defined in a surface 18′ of a mold 10′ and bridge 34″ is welded across the channel 30′ above the weld support 32″ for closing the channel 30′.

As shown, the weld support 32″ is a strip of rigid material (e.g., steel) and has a curved configuration. Unlike the weld support 32′, however, the weld support 32″ is not a tubular element but is a half-curved element. Also as shown, spaced apart lateral walls 40′, 42′ are generally parallel to one another (i.e., are not angled relative to one another); however, it should be appreciated that the lateral walls 40′, 42′ can be angled relative to one another with the weld support 32″ being supported on shoulders of the lateral walls 40′, 42′ as described above. In the method of FIGS. 5A-5D, the weld support 32″ is installed in the channel 30 at a location spaced apart from a lower end 30a′ of the channel 30′ and from the molding surface 18′, a concave side of the weld support 32″ facing toward the lower end 30a′ of the channel 30′ and a convex side of the weld support 32″ facing away from the lower end 30a′ of the channel 30′. As depicted, the convex side of the weld support 32″ defines a substantially circular shape with the lower end 30a′ of the channel 30′. The welder 44 can deposit fill material 54 (e.g., weld material) above the weld support 32″ to fill a cavity 52″ defined between the weld support 32″ and the molding surface 18′ of the mold 10′ (see FIG. 5B). As with the earlier described methods, the fill material 54 can completely fill the cavity 52″ and extend beyond the molding surface 18′ of the mold 10′ as shown in FIG. 5C. Thereafter, the fill material 54 can be reduced so that an upper surface 54a of the fill material 54 is contiguous with the molding surface 18′ of the mold 10′ as shown in FIG. 5D.

FIGS. 6A-6D illustrate yet another method for forming a fluid passage in a mold. The method of FIGS. 6A-6D can be the same as the method of FIGS. 5A-5D with the exception that the weld support 32″ is replaced by the weld support 32′ described in connection with the method of FIGS. 4A-4D. As shown in FIG. 6A, the weld support 32′ can be installed within the channel 30′ in a complementary relation. That is, the weld support 32′ can complementarily fit against the lower end 30a′ of the channel 30′ as shown in FIG. 6B. Then, with continued reference to FIG. 6B, the welder 44 can begin depositing fill material (e.g., weld material) 54 in the cavity 52″ disposed between the weld support 32′ and the molding surface 18′ of the mold 10′. The fill material 54 can continue to be deposited until the cavity 52″ is completely filled and can be filled so as to extend beyond the molding surface 18′ of the mold 10′ as shown in FIG. 6C. Thereafter, the fill material 54 extending beyond the molding surface 18′ can be reduced so that upper surface 54a of the fill material 54 is contiguous with the molding surface 18′ of the mold 10′. Optionally, the weld support 32′ can be a consumable weld support as described hereinabove and therefore can be dissolved as shown in FIG. 6D so as to no longer occupy space within the mold 10′.

According to the methods described herein, a method of forming a fluid passage in a mold is described that includes providing a molding surface with a channel having a closed bottom and an opening. The method further includes installing a weld support between a first wall and a second wall of the channel, wherein the weld support is positioned below the opening. Additionally, the method includes welding a bridge above the weld support between the first wall and the second wall of the channel, wherein the bridge is positioned below the opening to define the fluid passage. Providing the molding surface with a channel can optionally include at least one of cutting the channel into the mold surface, casting the mold with a channel defined in the mold surface, molding the mold with a channel defined in the mold surface, or welding the mold with the channel defined in the mold surface, though this is not required and the method can presume that a mold is already provisioned with the channel defined therein.

As will be appreciated and understood by those skilled in the art, the methods described herein can provide a part producing mold (e.g., mold 10, 10′) having a fluid passage 12 defined therein that includes the channel 30 or 30′ defined in the molding surface 18 or 18′ of the mold 10 or 10′, weld support 32, 32′ or 32″ received in the channel 30 or 30′ and the bridge 34, 34′ welded across the channel 30 or 30′ above the weld support for closing the channel and defining the fluid passage 12. The weld support can have one of a tubular configuration (weld support 32′), a planar strip configuration (weld support 32), or a curved strip configuration (weld support 32″). Also, the channel can be defined by spaced apart lateral walls depending from the surface of the mold and the spaced lateral walls can be at least one of parallel to one another (as shown in the methods of FIGS. 5A-5D and 6A-6D) or angled so that lower ends thereof converge towards one another (as shown in the methods of FIGS. 3A-3E and FIGS. 4A-4D) or can be curved (not shown herein).

It should also be appreciated and understood that any of the features associated with the methods discussed herein can be mixed and matched with other of the methods described herein. For example, the weld support 32″ could be used in association with the shoulders 46, 48 depicted in FIGS. 3A-3E and/or the angled lateral walls 40, 42 depicted in FIGS. 3A-3E.

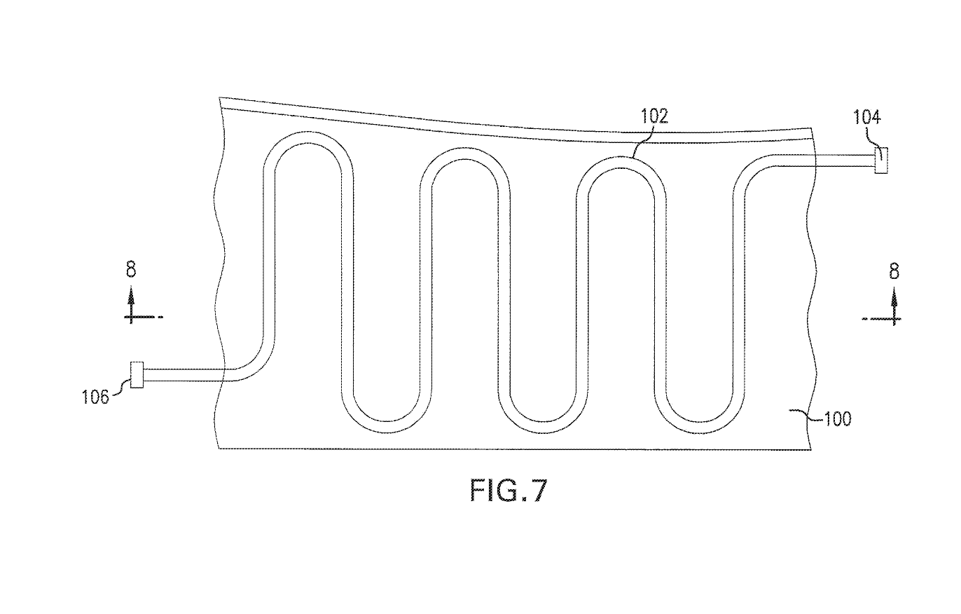

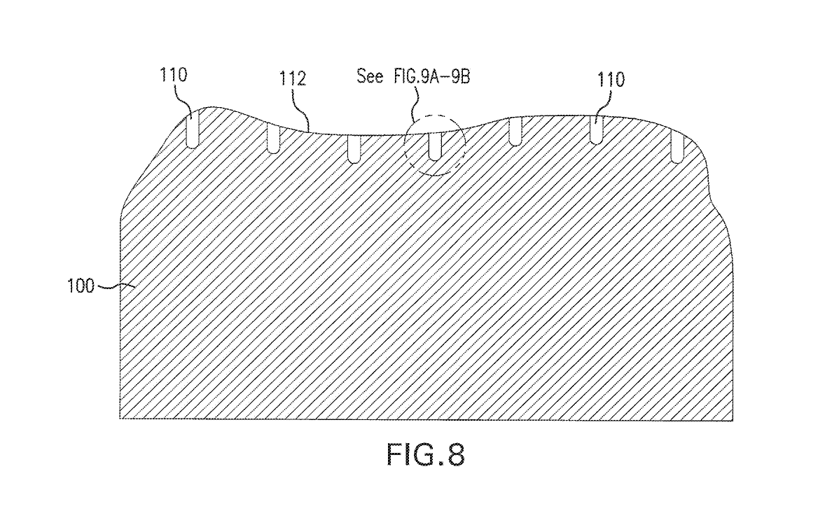

A plan view of an exemplary mold 100 having a sub-surface conformal cooling fluid passage 102 formed according to another aspect of the present disclosure is illustrated in FIG. 7. Again, although the mold 100 and the fluid passage 102 can only be shown in two dimensions herein, it should be understood, and is more readily apparent from FIGS. 8-10, that the mold would also generally have a contoured shape in a third dimension instead of the planar shape conveyed herein. That is, while the portion of the mold 100 overlying the fluid passage 102 may be planar, it is more likely to have at least some contour.

As shown in FIG. 7, this particular fluid passage 102 follows a circuitous path through the mold 100, from a coolant inlet 104 to a coolant outlet 106. The particular path followed by the fluid passage 102 in this embodiment is provided for purposes of illustration only, and the present invention is not limited to any particular coolant passage layout. Similarly, the size and spacing of the fluid passage sections and the spacing therebetween may also vary as necessary to provide the desired cooling effect. Further, while only one fluid passage is shown and described herein, it should also be realized that a given portion of a mold may have a plurality of individual fluid passages.

A method of creating the fluid passage 102 in the mold 100 is illustrated in FIGS. 8-10. As can be understood from a review of FIG. 8, a series of interconnected open passages or channels 110 are first cut into a molding surface 112 of the mold 100. The channels 110 may be placed into the mold 100 by any of various techniques such as, for example, with a CNC machining apparatus, or by any of the other techniques mentioned above or otherwise known in the art. The channels 110 are of some predetermined width and extend to some predetermined depth below the molding surface, as would generally be calculated based on various physical characteristics of the mold, the material that will be molded, the degree of desired cooling, etc.

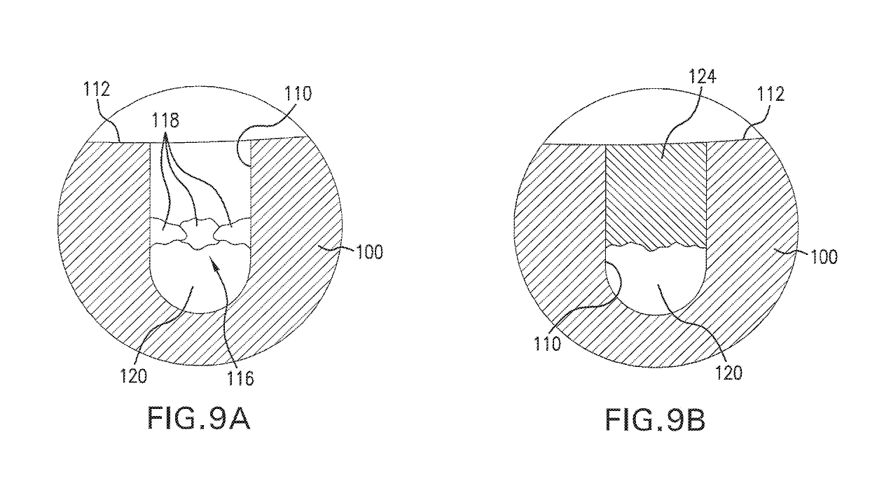

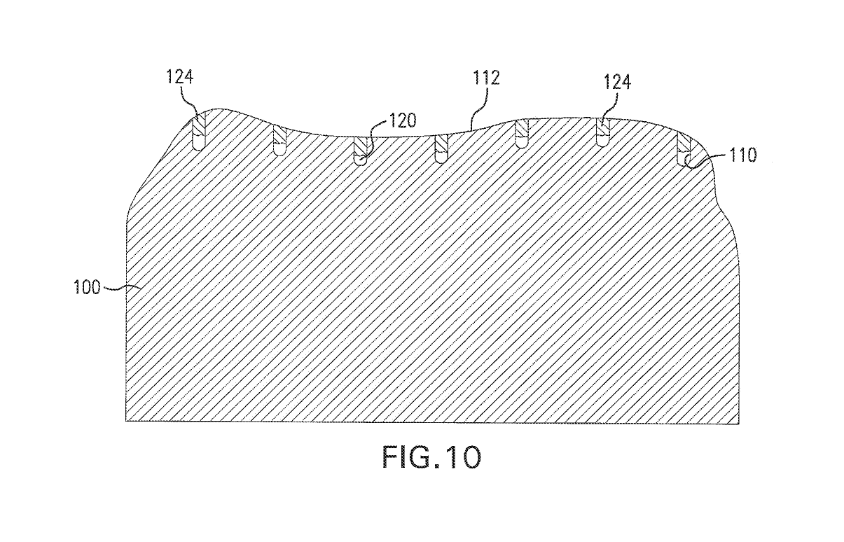

As most clearly shown in FIGS. 9A-9B, once the open channels 110 have been cut into the molding surface 112 of the mold h100, a 3-D welding process, such as a TIG, MIG, Stick or GAS welding process is used to produce a bridging weld 116 within each channel. For example, a robotic 3-D TIG welding process may be employed for this purpose. The 3-D welding process produces a series of small connected weld beads 118 that, together, span the width of the channel 110 and serve to seal the channel. While only three individual weld beads 118 are shown to bridge the channel 110 for purposes of clarity, it should be understood that a greater number of individual weld beads may be required in this regard. This bridging weld 116 is produced at some distance from the bottom of the channel 110 so as to enclose an open fluid passage 120 below the bridging weld.

As illustrated in FIG. 9B and FIG. 10, once each bridging welding operation is complete, the open area of each channel 110 above the bridging weld 116 is filled. In this particular embodiment, the open area of each channel 110 above the bridging weld 116 is filled with welding material 124. The use of other fillers may also be possible, such as, for example, epoxies.

According to the method of the present invention, the channels cut into a mold will typically be filled with welding material 124 until the welding material extends at least slightly above the molding surface of the mold half. After the remainder of the channels 110 are appropriately filled with welding material 124, the excess welding material is machined or otherwise shaped to the contour of the surrounding molding surface 112, as is also shown in FIG. 9B. The molding surface 112 can be subsequently provided with a Class A or similar finish that places the molding surface in condition to properly form a molded part. As can be best observed in FIG. 10, use of the aforementioned bridge weld 116 and subsequent filling of channels 110 cut into the molding surface 112 of the mold 100 allows for the production of a solid molding surface with an underlying open fluid passage 102.

A fluid passage produced in a mold by a method of the present disclosure may be connected to a source of coolant in a manner similar to that of other known mold cooling techniques. To that end, a fluid passage of the present disclosure may be constructed with an inlet end and an outlet end that are accessible from outside a mold. Such an exemplary construction is represented in FIG. 7.

It can be understood that a method(s) of the present disclosure allows for the formation of sub-surface conformal cooling fluid passages in part-producing molds. These cooling passages are able to substantially conform to the contour of the molding surface of a given mold and may reside near to the molding surface so as to provide effective and efficient cooling thereof. Because a cooling fluid passage(s) produced substantially conforms to and resides near the molding surface, molding surface cooling is more uniformly and efficiently accomplished than with previously known techniques.

The method(s) of the present disclosure may be used on various types of molds. For example, the method of the present invention may be used to produce conformal cooling passages in plastic injection molds through which cooling fluid is circulated. However, as described above, a method of the present disclosure may also be used to produce conformal cooling passages in a plastic compression, blow forming or vacuum forming mold, a metal casting die, and may be used with other temperature controlled manufacturing processes that employ cooperating preset forms to create an object from a provided supply of material.

Further, although the present disclosure is directed at forming passages for circulating cooling fluid, it should be apparent that the method(s) of the present disclosure may also be employed to form conformal fluid circulating passages in a mold or die, regardless of whether the circulated fluid is used to cool or heat the mold/die. Therefore, although the method(s) of the present disclosure produces good results when used to produce conformal mold cooling passages for the cooling of molds, the present invention is not limited to mold cooling applications.

It will also be appreciated that above-disclosed features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A part producing mold having a cooling fluid passage defined therein, comprising:
a channel defined in a mold surface of the mold by spaced apart lateral walls depending from the mold surface of the mold toward a closed bottom of the channel;
a nonconsumable steel weld support received in the channel and positioned adjacent the closed bottom; and
a bridge welded across the channel onto and above the weld support and directly to the lateral walls for closing the channel and defining the fluid passage.

2. The part producing mold of claim 1 wherein the weld support has one of a tubular configuration, a planar strip configuration or a curved strip configuration.

3. The part producing mold of claim 1 wherein the weld support has a curved strip configuration with a concave side facing toward the closed bottom of the channel and a convex side facing away from the closed bottom of the channel, wherein the convex side of the weld support defines a substantially circular shape with the closed bottom of the channel.

4. The part producing mold of claim 1 wherein the spaced apart lateral walls are at least one of parallel with one another or angled so that lower ends thereof converge toward one another or curved.

5. The part producing mold of claim 4 wherein the spaced apart lateral walls are angled and the lower ends of the spaced apart lateral walls are spaced apart from the closed bottom of the channel.

6. The part producing mold of claim 5 wherein spaced apart shoulders are defined adjacent the lower ends of the spaced apart lateral walls and the shoulders are spaced apart from the closed bottom of the channel.

7. The part producing mold of claim 6 wherein the weld support is directly supported on the shoulders of the lateral walls.

8. A part producing mold having improved cooling capabilities, comprising:
at least one conformal cooling passage located subjacent to a molding surface of the mold to be cooled, the at least one conformal cooling passage formed from:
a series of interconnected open channels placed in the molding surface, the channels substantially conforming to the contour of the molding surface,
a bridging weld located within each channel, the bridging weld comprising a series of connected weld beads, the bridging weld spanning and sealing each channel and located at some distance from a bottom of each channel so as to form an enclosed cooling passage at the bottom thereof, and
a plurality of weld beads that solidly fill a remaining volume of each channel above the bridging weld to close each channel, the weld beads at an open end of each channel shaped to conform to the molding surface of the mold surrounding that channel;
an inlet associated with the at least one conformal cooling passage for receiving pressurized cooling fluid from a source thereof; and
an outlet associated with the at least one conformal cooling passage for expelling cooling fluid after the cooling fluid has passed through the at least one conformal cooling passage.

9. The part producing mold of claim 8, wherein the channels includes a first channel and a second channel either upstream or downstream of the first channel, the bottom of the passage in at least a portion of the first channel has an elevation different than the bottom of the passage in at least a portion of the second channel,
wherein the mold surface includes a recessed portion positioned between a first raised portion and a second raised portion, the second channel is positioned on the mold surface in the recessed portion and the first channel is positioned on the mold surface outside of the recessed portion.

10. The part producing mold of claim 8, wherein the inlet and outlet of the at least one conformal cooling passage are accessible from an exterior of the mold.

11. A method for forming a conformal fluid circulating passage in a part-producing mold, comprising:
providing a mold including a molding surface with an open passage thereon, the depth of the open passage substantially conforming to the contour of the molding surface, the open passage defining a plurality of open channels including a first channel, a second channel downstream of the first channel and a third channel downstream of the second channel, a bottom of the open passage in at least a portion of the first channel has an elevation different than a bottom of the open passage in at least a portion of one of the second channel and the third channel; and
wherein each fluid channel defines a centerline that extends from the bottom of the open passage to the molding surface and a channel longitudinal centerline, and the method includes maintaining a common distance between the longitudinal centerlines and the molding surface and between the centerlines of adjacent channels.

12. The method of claim 11, wherein the common distance between the centerlines of adjacent channels is at least partially determined by a diameter of each adjacent channel.

13. The method of claim 11, further including:
placing a weld support within each channel and a separate bridge weld over the weld support, the weld support is located at some distance from the bottom of the passage to form an enclosed passage at the bottom thereof,
wherein each channel has a midpoint along a centerline of the channel that extends from the bottom of the open passage to the molding surface and the weld support is at least partially below the midpoint.
